(19) United States
(12) Patent Application Publication
(10) Pub. No.: US 2026/0366383 A1
(43) Pub. Date: Nov. 19, 2026

(54) METHOD AND SYSTEM FOR PRODUCTION CHOKE MANAGEMENT

(71) Applicant: SAUDI ARABIAN OIL COMPANY, Dhahran (SA)

(72) Inventors: Mohammed Elmetwally Gomaa, Ras Tanura (SA); Zoran Mrsic, Ras Tanura (SA); Abdul Raheman Mohammed, Al Hofuf (SA); Attiq Goraya, Ras Tanura (SA)

(73) Assignee: SAUDI ARABIAN OIL COMPANY, Dhahran (SA)

(21) Appl. No.: 19/209,131

(22) Filed: May 15, 2025

(51) Int. Cl. E21B 21/08; E21B 21/10

(52) U.S. Cl. CPC E21B 21/08; E21B 21/106; E21B 2200/20

(57) ABSTRACT

A method for setting a valve position of a choke valve on a pipeline includes obtaining real-time operating data relating to the choke valve from a plurality of sensors on the pipeline. The plurality of sensors includes a choke valve positioner configured to transmit and set the valve position and an acoustic sensor downstream from the choke valve configured to transmit an acoustic signature of a fluid flowing in the pipeline. The operating data includes the valve position and the acoustic signature. The method utilizes a first model using the operating data to perform a verification assessment. The verification assessment identifies at least one condition of the choke valve, determines a conditioned valve position based on the at least one condition, and sets the valve position to the conditioned valve position using the choke valve positioner.

### BACKGROUND

During the operation of a well in an oil and gas field, the primary valve used for controlling the production rate is known as a choke valve. This valve is typically employed to regulate the flow and pressure of fluids. However, the harsh conditions experienced by these choke valves often lead to failures caused by erosion and cavitation. This is particularly evident when dealing with the high-pressure, high-velocity flow of sour gas, liquid droplets, and debris. As a result, approximately 10% of installed chokes need to be replaced on an annual basis. This replacement process incurs both costs and production delays.

Currently, there is no unified tool for validation and verification of the choke manifold in one single platform. In instances where more than one choke valve is used, for example, on an oil and gas field consisting of multiple wells, the choke valves may come from different vendors. In such a case, choke manifold data cannot be analyzed across the oil and gas field in a unified manner. Further, choke valves, sensors, and supporting equipment may malfunction. When equipment fails, vital data relating to the performance of the choke valve is unavailable to an operator or well and field analysis system, and estimation alone could be inaccurate. Additionally, a reliable tool to predict metal loss due to erosion and cavitation in the choke manifold is unavailable.

Accordingly, there exists a need for a unified, vendor-independent production choke management system that can automatically monitor and analyze the performance of production choke valves, well production rate control, and predict and detect choke failures in real time, without human intervention.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for setting a valve position of a choke valve disposed on a pipeline, the method comprising obtaining real-time operating data relating to the choke valve from a plurality of sensors disposed on the pipeline, wherein the plurality of sensors comprises a choke valve positioner configured to transmit and set the valve position, and an acoustic sensor disposed downstream from the choke valve configured to transmit an acoustic signature of a fluid flowing in the pipeline, wherein the operating data comprises the valve position and the acoustic signature; performing, by a first model using the operating data, a verification assessment, wherein the verification assessment identifies at least one condition of the choke valve; determining a conditioned valve position based on the at least one condition; and setting the valve position to the conditioned valve position using the choke valve positioner.

In one aspect, embodiments disclosed herein relate to a system, comprising a choke valve disposed on a pipeline; a plurality of sensors disposed on the pipeline, wherein the plurality of sensors comprises a choke valve positioner configured to transmit and set a valve position for the choke valve, and an acoustic sensor disposed downstream from the choke valve configured to transmit an acoustic signature of a fluid flowing in the pipeline; a data verification tool, configured to: obtain real-time operating data relating to the choke valve from the plurality of sensors, wherein the operating data comprises the valve position and the acoustic signature; perform, by a first model and using the operating data, a verification assessment, wherein the verification assessment identifies at least one condition of the choke valve; determine a conditioned valve position based on the at least one condition; and set the valve position to the conditioned valve position using the choke valve positioner; an action points alarm tool, configured to generate a status report comprising the at least one condition and a recommended action associated with the at least one condition; and a display configured to: receive the status report from the action points alarm tool; and present the status report to an operator.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1A depicts a pipeline in accordance with one or more embodiments.

FIG. 1B depicts a pipeline in accordance with one or more embodiments.

FIG. 2 depicts a system in accordance with one or more embodiments.

FIG. 3 depicts a flowchart in accordance with one or more embodiments.

FIG. 4 depicts a neural network in accordance with one or more embodiments.

FIG. 5 depicts a flowchart in accordance with one or more embodiments.

FIG. 6 depicts a computer system in accordance with one or more embodiments.

FIG. 7 depicts a flowchart in accordance with one or more embodiments.

FIG. 8 depicts a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “choke valve” includes reference to one or more of such choke valves.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

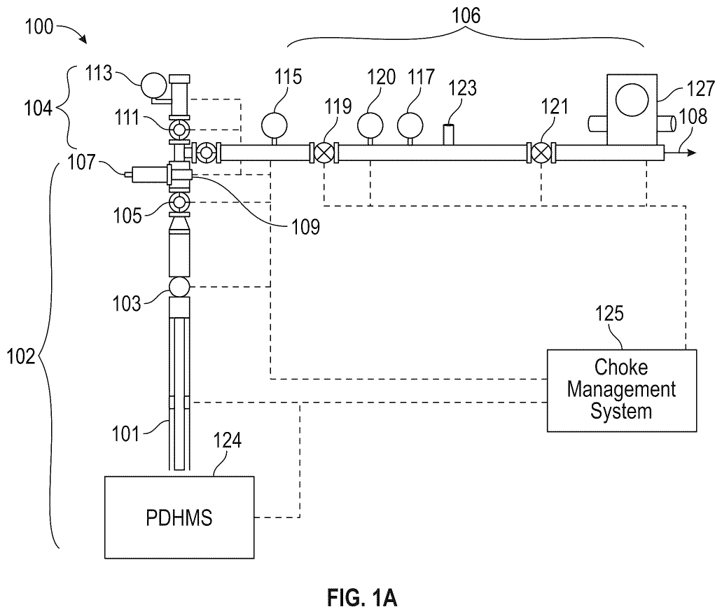

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Further, embodiments disclosed herein are described with terms designating a rig site in reference to a land rig, but any terms designating rig type should not be deemed to limit the scope of the disclosure. For example, embodiments of the disclosure may be used on an offshore rig and various rig sites, such as land/drilling rig and drilling vessel. It is to be further understood that the various embodiments described herein may be used in various stages of a well, such as rig site preparation, drilling, completion, abandonment etc., and in other environments, such as work-over rigs, fracking installation, well-testing installation, and oil and gas production installation, without departing from the scope of the present disclosure. The embodiments are described merely as examples of useful applications, which are not limited to any specific details of the embodiments herein.

In one aspect, embodiments of the disclosure include a choke management system and method(s) of its use for production choke valve management. The choke management system is an integrated, automated system that verifies, validates, and reports choke valve performance in real time. Through real time monitoring of the choke valve, the use of the choke management system ensures that well operations remain within the erosion-free zone of the choke valve performance envelope, while simultaneously assessing the condition of the choke valve and predicting potential choke valve failures through the use of Artificial Intelligence and Machine Learning (AI/ML) models. This approach has the added benefit of increasing the run life of the choke valve and optimizing safety, maintenance, and choke valve replacement operations by allowing for accurate timing and planning of choke valve maintenance and replacement. Additionally, the choke management system provides a means for estimating fluid pressure and flowrate measurements to ensure the choke valve remains properly calibrated in the event of an equipment malfunction or failure.

The choke management system utilizes real-time measurements of the choke valve and choke manifold using various instrumentation components, existing and new. These measurements are compared to other data and historical records to ensure accuracy. Additionally, the choke management system includes estimation pressure monitoring to maintain testing efficiency in the event of a failure of the choke manifold hardware.

The estimation pressure monitoring feature utilizes multiple ML techniques to estimate pressure based on real-time, field-derived operating data such as wellhead pressure, temperature, reservoir pressure, fluid properties, Electrical Submersible Pump (ESP) frequency, and ESP motor current. Operators can choose the technique that best suits the operation and provides the highest accuracy and lowest error. This process is validated to ensure reliability.

Furthermore, the choke management system may detect anomalies in the choke manifold raw data and identify faulty sensors. Pre-defined logic and ML techniques may be used to recommend actions to address detected errors and anomalies, ensuring the accuracy of the choke valve manifold. The verification process adds an extra layer of reliability.

Lastly, based on the healthiness of the choke manifold, the system can identify the necessary action items for the appropriate organization to address. Alarms and triggers are generated based on pre-defined logics and readings of the main parameters of the choke manifold. This ensures that any equipment malfunctions are promptly addressed.

Resultant features of the choke management system include providing a fully reliable system that identifies errors and delivers accurate results. Oil and gas companies and technology providers can utilize this analytics system to optimize choke manifold maintenance visits, particularly in offshore environments.

Choke metal loss prediction is a critical aspect of industrial maintenance and safety, especially in oil and gas industries that handle corrosive materials and operate under extreme conditions. The choke management system can be used to predict the rate at which metal components of a choke valve will deteriorate over time, allowing maintenance teams to proactively address potential issues before they become serious concerns and improving asset management in various industries.

By monitoring metal loss rates over time, patterns and trends can be identified that may indicate areas of concern, enabling preventive action to be taken to avoid costly downtime or safety risks. Additionally, the effects of operating conditions on metal surfaces can be predicted and maintenance programs can be implemented to prevent failures and ensure efficient operation.

In accordance with one or more embodiments, the choke management system may be configured to receive operating data from one or more existing sensor devices disposed along the pipeline in the vicinity of the choke valve. Operating data may consist of, for example, choke valve position, fluid pressure, fluid temperature, and flowrate measurements. Typically, production well equipment, such as that disclosed in FIG. 1A below, may be procured from different vendors and manufacturers. A benefit of the choke management system described herein is that the systems and methods are compatible with any sensor device or choke valve, regardless of the vendor or manufacturer of the equipment. As the choke management system is vendor and manufacturer-independent, the solution can be configured to monitor the health of multiple chokes in a field-wide system under a single control hub.

In addition to monitoring the choke valve through sensor devices such as pressure sensors, a flow sensor, a temperature sensor, and a choke valve position sensor, the choke management system may utilize acoustic data provided by an acoustic sensor disposed on the pipeline downstream from the choke valve. The installation of an acoustic sensor may allow for the capture of the acoustic signature of the fluid flowing through the choke valve. One or more embodiments use the acoustic signature to determine, among other things, the extent of erosion of the associated choke valve.

In some embodiments, the choke management system may utilize a metal-loss algorithm to aid in quantifying deterioration of the choke valve which can subsequently be used to predict a failure of the choke valve. The metal-loss algorithm may analyze data from, for example, valve position sensors, a flow meter, upstream and downstream pressure sensors, and acoustic data from downstream the choke valve. By comparing real-time data against historical data, the choke management system can determine an accurate condition of the choke valve.

In accordance with one or more embodiments, the choke management system may be utilized in the operation of a High Pressure High Temperature (HPHT) gas well. FIG. 1A depicts a simplified portion of a pipeline (100) of a well in an oil and gas field. Herein, an oil and gas field is broadly defined to consist of wells which produce at least some oil and/or gas. Hydrocarbon wells typically produce oil, gas, and water in combination. The relative amounts of oil, gas, and water may differ between wells and vary over the lifetime of any one well.

For clarity, the pipeline (100) is divided into three sections; namely, a subsurface (102) section, a tree (104) section, and a flowline (106) section. It is emphasized that pipelines (100) and other components of wells and, more generally, oil and gas fields may be configured in a variety of ways. As such, one with ordinary skill in the art will appreciate that the simplified view of FIG. 1A does not impose a limitation on the scope of the present disclosure. As part of the subsurface (102) section, FIG. 1A shows an inflow control valve (ICV) (101). An ICV (101) is an active component usually installed during well completion. The ICV (101) may partially or completely choke flow into a well. Generally, multiple ICVs (101) are installed along the reservoir section of a wellbore. Each ICV (101) is separated from the next by a packer. Each ICV (101) can be adjusted and controlled to alter flow within the well and, as the reservoir depletes, prevent unwanted fluids from entering the wellbore.

The subsurface (102) section of the pipeline (100) has a subsurface safety valve (SSSV) (103). The SSSV (103) is designed to close and completely stop flow in the event of an emergency. Generally, an SSSV (103) is designed to close on failure. That is, the SSSV (103) requires a signal to stay open and loss of the signal results in the closing of the valve. Also shown as part of the subsurface (102) section is a permanent downhole monitoring system (PDHMS) (124). The PDHMS (124) consists of a plurality of sensors, gauges, and controllers to monitor subsurface flowing and shut-in pressures and temperatures. As such, a PDHMS (124) may indicate, in real-time, the state or operating condition of subsurface equipment and the fluid flow.

Turning to the tree (104) section of FIG. 1A is a master valve (MV) (105), a surface safety valve (SSV) (107), and a wing valve (WV) (109). The MV (105) controls all flow from the wellbore. For safety considerations, an MV (105) is usually considered so important that two master valves (MVs) (second not shown) are used wherein one acts as a backup. Like unto the SSSV (103), the SSV (107) is a valve installed on the upper portions of the wellbore to provide emergency closure and stoppage of flow. Again, SSVs (107) are designed to close on failure. One or more WVs (109) may be located on the side of the tree (104) section, or on temporary surface flow equipment (not shown). WVs (109) may be used to control and isolate production fluids and/or be used for treatment or well-control purposes.

Also shown in FIG. 1A is a control valve (CV) (111) and a pressure gauge (PG) (113). The CV (111) is a valve that controls a process variable, such as pressure, flow, or temperature, by modulating its opening. The PG (113) monitors the fluid pressure at the tree (104) section.

Turning to the flowline (106) section, the flowline (106) transports (108) the fluid from the well to a storage or processing facility (not shown). A choke valve (119) is disposed along the flowline (106). The choke valve (119) is used to control flowrate and reduce pressure for processing the extracted fluid at a downstream processing facility. In particular, effective use of the choke valve (119) prevents damage to downstream equipment and promotes longer periods of production without shut-down or interruptions. The choke valve (119) is bordered by an upstream pressure sensor (115) and a downstream pressure sensor (117) which monitor the pressure of the fluid entering and exiting the choke valve (119), respectively. The flowline (106) shown in FIG. 1A has a block and bleed valve system (121) which acts to isolate or block the flow of fluid such that it does not reach other downstream components. A flow meter (127) is installed on the flowline (106) to measure the rate of the fluid produced from the well. In some implementations, the flow meter (127) can be a multiphase flow meter (MPFM) capable of determining flow rates for each phase-oil, gas, water—of fluid flowing from the well. That is, an MPFM may detect the instantaneous amount of gas, oil, and water flowing in the pipeline (100). An MPFM is advantageous in that it can be configured to measure the flow rate of one well or multiple wells of a well operation. The flowline (106) may also be outfitted with one or more temperature sensors (123) and acoustic sensors (120). The acoustic sensor (120) may be installed downstream from the choke valve (119) to monitor the acoustic signature of the fluid passing through the flowline (106).

The various valves, pressure gauges and transducers, and sensors depicted in FIG. 1A may be considered field devices of an oil and gas field. As shown, these field devices may be disposed both above and below the surface of the Earth. These field devices are used to monitor and control components and sub-processes of an oil and gas field. It is emphasized that the oil and gas field devices depicted in FIG. 1A are non-exhaustive. Additional devices, such as electrical submersible pumps (ESPs) (not shown) may be present in an oil and gas field with their associated sensing and control capabilities. For example, an ESP may monitor the temperature and pressure of a fluid local to the ESP and may be controlled through adjustments to ESP speed or frequency.

The field devices may be distributed, local to the sub-processes and associated components, global, connected, etc. The field devices may be of various control types, such as a programmable logic controller (PLC) or a remote terminal unit (RTU). For example, a programmable logic controller (PLC) may control valve states, pipe pressures, warning alarms, and/or pressure releases throughout the oil and gas field. In particular, a programmable logic controller (PLC) may be a ruggedized computer system with functionality to withstand vibrations, extreme temperatures, wet conditions, and/or dusty conditions, for example, around a pipeline (100). With respect to an RTU, an RTU may include hardware and/or software, such as a microprocessor, that connects sensors and/or actuators using network connections to perform various processes in the automation system. As such, a distributed control system may include various autonomous controllers (such as remote terminal units) positioned at different locations throughout the oil and gas field to manage operations and monitor sub-processes. Likewise, a distributed control system may include no single centralized computer for managing control loops and other operations.

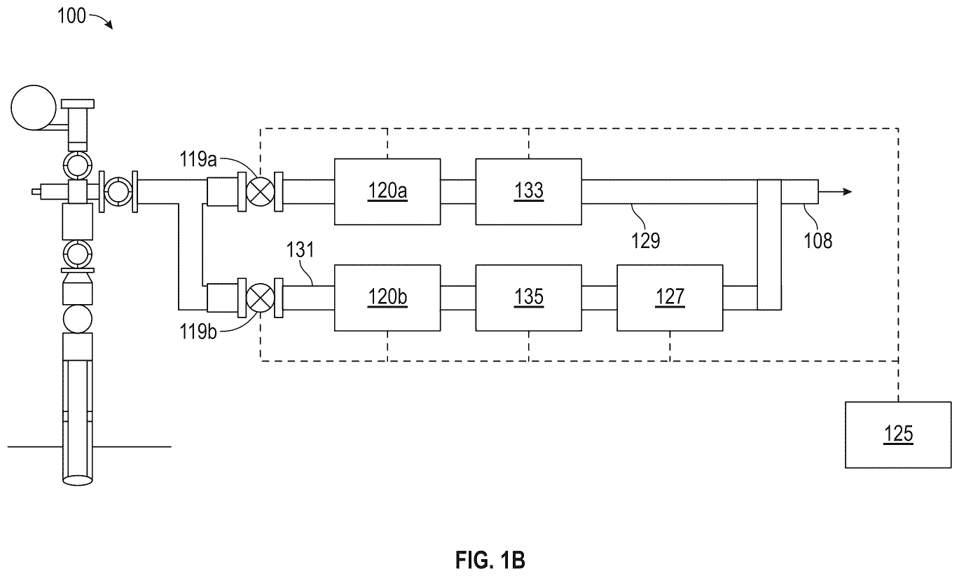

In accordance with one or more embodiments, FIG. 1A depicts a choke management system (125). The choke management system (125) may include functionality for field device monitoring and data collection. In one or more embodiments, the choke management system (125) may further include functionality for issuing field device commands. As will be described in greater detail with reference to FIG. 2, the choke management system (125) may include functionality to output and visualize choke valve performance information to a control room or operations center, analyze sensor data for malfunctions, automatically validate choke valve performance, intelligently recommend preventative maintenance activities related to the choke valve (119), provide alerts and/or alarms to a control room or operations center, estimate a choke valve opening from field device data, and continuously provide accurate choke valve calibration measurements regardless of the state of pressure sensors, flow meters, or other vital equipment. To emphasize that the choke management system (125) can monitor and, in some embodiments, control the various field devices of a well and/or an oil and gas field, dashed lines connecting various field devices to the choke management system (125) are shown in FIG. 1A.

In accordance with one or more embodiments, the choke management system (125) may be in communication with or incorporated into a supervisory control and data acquisition (SCADA) system. A SCADA system is a control system that includes functionality for device monitoring, data collection, and issuing of device commands. The SCADA system enables local control at an oil and gas field as well as remote control from a control room or operations center.

In accordance with one or more embodiments, FIG. 1B shows a simplified version of pipeline (100) with two lines-a production line (129) and a test line (131). As can be appreciated by one with ordinary skill in the art, a test line (131) may be used to evaluate the properties of a well or well fluid that is produced from the well. Generally, all flow goes through the production line (129). However, when a well requires testing, the production manifold is closed, and the test manifold is opened. As a result, fluid flows into the test line (131).

In a multi-well platform or an onshore drill site, an individual well typically flows to the production header. Before the flow line connects to the production header, the flow line splits into two lines. One line may connect to the production header, and the other line may connect to the test header. Each line may be equipped with a diversion valve, such as a Motor Operated Valve (MOV). As shown in FIG. 1B, a production MOV (133) is installed at the branch leading to the production header, and a test MOV (135) is installed at the branch leading to the test header. The test line (131) may be used to direct the flow to a flow meter (127), such as an MPFM as described in FIG. 1A. When testing is complete, fluid may flow from the test line (131) to the main production line (129), where the production line (129) transports (108) the fluid to a storage or processing facility (not shown).

Advantageously, wellsites constructed using two lines, such as the production line (129) and the test line (131) as described in FIG. 1B, may equip each line with an acoustic sensor (120a, 120b) downstream from the adjacent choke valve (119a, 119b). Each acoustic sensor (120a, 120b) may be configured with an auto switchover which will enable the correct sensor to be auto-selected based on the open or close status of the diverting MOV (133, 135).

Continuing with FIG. 1B, choke management system (125) may be in communication with field devices on both the production line (129) and the test line (131). To emphasize that the choke management system (125) can monitor and, in some embodiments, control the various field devices of both lines (129, 131), dashed lines connecting various field devices to the choke management system (125) are shown in FIG. 1B.

In accordance with one or more embodiments, FIG. 2 shows an example system (200) for, among other things, setting a valve position of a choke valve (119) disposed on a pipeline (100). The example system includes a plurality of sensors (202), a display (214), and a choke management system (125).

The plurality of sensors (202) may be any number of sensor devices and equipment located along the pipeline (100) of a well. In particular, the plurality of sensors (202) can be located in proximity to a choke valve (119) of the well and may be designed to provide operating data relating to the health and performance of the choke valve (119) in real-time. Non-limiting examples of the plurality of sensors (202) may include a choke valve positioner (204), an acoustic sensor (120), an upstream pressure sensor (115), a downstream pressure sensor (117), a temperature sensor (123), and a flow meter (127). In one or more implementations, the flow meter (127) is a multiphase flow meter (MPFM) such that the operating data further includes quantities such as mixture density, volumetric flowrates for water, oil, and gas, water cut, and gas-to-oil ratio. The operating data can further include derived quantities such as a pressure differential determined using two pressure sensors. The operating data can further include static properties (or properties not expected to change with time) that, for example, describe a pipeline (100) such as an inner diameter of a flowline (106), a size or configuration of a choke valve, etc.

In one or more embodiments, the choke valve positioner (204) may be a component of the choke valve (119) that can be designed to transmit and set a choke valve position of the choke valve (119). As previously described, a choke valve (119) is a type of flow control device used to regulate the flow of well fluids in a pipeline (100). A regulating component such as a plug or needle may be actuated within the choke valve (119) to create a restriction in the pipeline (100), thus affecting the flowrate. The position of the regulating component, also referred to as the choke valve position, may be controlled by the choke valve positioner (204). The choke valve position may be set by the choke valve positioner (204) based on a variety of parameters, such as, for example, fluid pressure, fluid temperature, or flowrate. The choke valve positioner (204) can be manual or powered, and may be controlled by a lever, knob, electric motor, or hydraulic cylinder. A control system may be incorporated into the choke valve positioner (204) to automatically adjust the choke valve position in response to a received command (e.g., Command X (290)), where the command can originate from the choke management system (125). Further, the choke valve positioner (204) can be configured to transmit the choke valve position to an external system, such as the choke management system (125), in the form of operating data. The control system of the choke valve positioner (204) may include sensors, switches, and controllers.

The acoustic sensor (120) may be an acoustic monitoring device designed to clamp onto the pipeline (100) in the proximity of the choke valve (119). As fluid passes through the restriction caused by the choke valve (119), turbulence may be generated. The acoustic sensor (120) can sense vibrations discharged through the pipeline (100) by the turbulence generated from the high-velocity fluid passing through the choke valve (119). The vibrations are measured by the acoustic sensor (120) in the form of an acoustic signature, and in particular, an ultrasonic frequency. The acoustic sensor (120) can be configured to transmit the detected acoustic signature to an external system, such as the choke management system (125), in the form of operating data.

In one or more embodiments, raw acoustic data obtained from the acoustic sensor (120) includes unprocessed data such as sound waves, frequencies, and amplitudes. Such raw acoustic data may be obtained by the choke management system (125) from the acoustic sensor (120) as operating data. Raw acoustic data can contain fundamental information that is crucial when analyzing the fluid flow and determining choke conditions. To determine conditions of the choke valve (119) and choke manifold, the raw acoustic data must be processed and analyzed. This involves using algorithms and/or models that interpret the acoustic signatures to identify patterns indicative of specific choke conditions. For instance, certain sound patterns may correspond to increased turbulence, blockages, or wear and tear on the choke valve (119). The acoustic sensor data can be integrated with diagnostic tools and corresponding models, such as the Data Verification Tool (206), the Data Validation Tool (208), and the Prognosis Tool (210), to enhance the accuracy and reliability of the system. This comprehensive approach allows for a more detailed and accurate assessment of the condition of the choke valve (119) and choke manifold.

Fluid flowing through the choke valve (119) may contain a mixture of liquid, gas, and solid particles, such as sand. As the fluid flows through the choke valve (119), the material forming the components of the choke valve (119) may experience erosion and cavitation, especially under high-pressure, high-velocity fluid flows. As the restriction in the choke valve (119) changes due to erosion, the acoustic signature detected by the acoustic sensor (120) may increase. Changes, such as spikes or trends, in the acoustic signature detected over time may be a significant indicator of the extent of erosion of the choke valve (119). To achieve optimal monitoring of the choke valve (119) via the acoustic sensor (120), the preferred placement of the acoustic sensor (120) on the pipeline (100) may be downstream from the choke valve (119).

As previously discussed, wellsites constructed using two lines, such as the production line (129) and the test line (131) of the wellsite described in FIG. 1B, may equip each line with an acoustic sensor (120a, 120b) downstream from the adjacent choke valve (119a, 119b). Thus, at any point in time, one acoustic sensor (120a, 120b) may be experiencing flow. Each acoustic sensor (120a, 120b) may be configured with an auto switchover which will enable the correct sensor to be auto-selected based on the open or closed status of the diverting MOV (133, 135). Accordingly, the choke management system (125) may be configured to interchangeably receive operating data from either acoustic sensor (120a, 120b) based on the acoustic sensor (120a, 120b) that is currently experiencing flow.

The upstream pressure sensor (115) may be installed on the pipeline (100) upstream from the choke valve (119) to monitor the pressure of the fluid prior to entering the choke valve (119). The downstream pressure sensor (117) may be installed on the pipeline (100) downstream from the choke valve (119) to monitor the pressure of the fluid as the fluid exits the choke valve (119). Measuring the fluid pressure in this way may provide valuable insight into the health and performance of the choke valve (119). In some implementations, the operating data includes a determination of a differential pressure across the choke valve using the upstream pressure sensor (115) and the downstream pressure sensor (117).

The upstream pressure sensor (115) and the downstream pressure sensor (117) may be referred to collectively as pressure sensors (115, 117). The pressure sensors (115, 117) may be electromechanical devices such as pressure transducers or pressure transmitters that measure the upstream pressure and downstream pressure in the pipeline (100) and transmit the measured upstream pressure and downstream pressure to an external system, such as the choke management system (125), as operating data.

The temperature sensor (123) may be installed on the pipeline (100) proximate to the choke valve (119) and configured to measure the temperature of the fluid. Fluctuations or spikes in the temperature of the fluid may affect the flow rate and pressure of the fluid, which can subsequently impact the performance of the choke valve (119). Higher fluid temperatures can also accelerate erosion and cavitation of the choke valve (119). The temperature sensor (123) may be a device such as a fiber optic sensor, thermocouple, or an infrared thermography device which transmits the fluid temperature to an external system, such as the choke management system (125), as operating data.

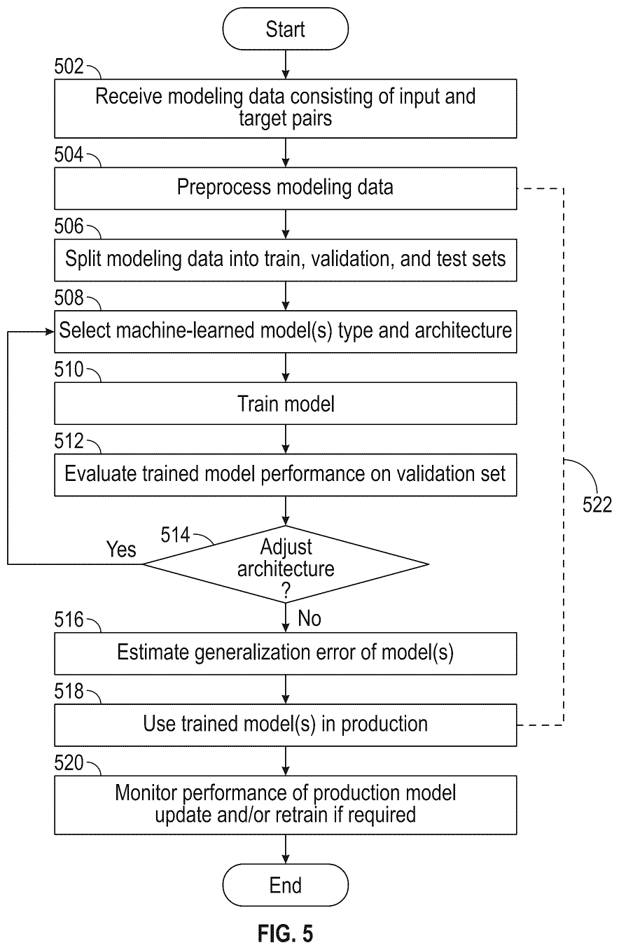

As previously described in FIG. 1A, the flow meter (127) is a device installed on the pipeline (100) to measure the flow rate of the fluid conveyed by the pipeline (100). In one or more embodiments, the flow meter (127) is a multiphase flow meter (MPFM) configured to determine the rate at which each phase of the fluid-oil, gas, water—is flowing. In general, an MPFM cannot directly measure the flowrate of the individual phases in a fluid. Rather, an MPFM is a collection of sensors, transmitters, mechanical devices, flow conduits, and programmed relationships that are used to determine the individual phase flowrates. The MPFM may be disposed in-line with a flowline (106) proximate to the choke valve (119) such that the MPFM can receive the multiphase fluid through a flow inlet and return the multiphase fluid through a flow outlet. The MPFM may be outfitted with a flow computer (e.g., a computer system as illustrated in FIG. 6) designed to receive the readings from the collection of sensors of the MPFM. That is, the flow computer acts, in part, as a data acquisition unit. Upon collecting the sensor data, the flow computer calculates the individual flowrates of the oil, gas, and water present in the multiphase fluid. The flow computer, or more generally, a flow meter (127) can transmit the computed flowrate(s) to an external system, such as the choke management system (125), as operating data.

The choke management system (125) can be a computer system (e.g., a computer system as illustrated in FIG. 6) consisting of, or configured to execute, four components/functions: a Data Verification Tool (206), a Data Validation Tool (208), a Prognosis Tool (210), and an Action Points Alarm Tool (212). Each component is examined in detail below.

In one or more embodiments, an intent of the Data Verification Tool (206) is to confirm the accuracy of the operating data, thus ensuring that the choke management system (125) is operating with consistent and reliable information. Verifying that the operating data is reliable can be crucial to the overall effectiveness of the choke management system (125). The Data Verification Tool (206) can remotely monitor and evaluate the overall health and performance of the choke valve (119) and the choke manifold in real-time using predefined logic applied to the field-derived operating data provided by the plurality of sensors (202). As a result, the Data Verification Tool (206) allows for real-time oversight and timely interventions, enhancing the overall performance and reliability of the well system.

As described, non-limiting examples of operating data may be valve position, acoustic signature, flow rate, temperature, upstream pressure, and downstream pressure as received from the choke valve positioner (204), acoustic sensor (120), flow meter (127), temperature sensor (123), upstream pressure sensor (115), and downstream pressure sensor (117), respectively. The Data Verification Tool (206) may be designed to efficiently analyze the raw operating data provided by the plurality of sensors (202) using multiple parameters and predefined logic, ensuring that the operating data used for analysis is consistent and reliable.

Once obtained, the Data Verification Tool (206) may process the operating data with a first model for the choke valve (119). The first model may be a computational model (or so-called “digital twin”) of the choke valve (119), showing a snapshot of the current state of the choke valve (119) based on the real-time operating data. The Data Verification Tool (206) can use the first model to verify the accuracy and consistency of the operating data, ensuring that the inputs to the Data Validation Tool (208) and the Prognosis Tool (210) are reliable. Using the first model, the Data Verification Tool (206) can proceed to perform a verification assessment, resulting in the identification of at least one condition of the choke valve (119). FIG. 2 depicts an output of the choke management system (125) as one or more choke valve conditions (250). The choke valve conditions (250) include, or are synonymous with, the described at least one condition of the choke valve (119).

The verification assessment can utilize a condition monitoring algorithm to evaluate the first model. The condition monitoring algorithm analyzes the operating data applied to the first model, looking for specific features and relationships within the operating data that exhibit changes in behavior that may indicate a potential degradation within the choke valve (119) or an indication that one of the plurality of sensors (202) is defective. The first model may be compared against established markers of a faulty choke valve (119). A marker of a faulty choke valve (119) may be, for example, a reduced valve opening at the same upstream and downstream pressure, the same flow rate, and an increased acoustic signature (e.g., increased signal amplitude or power spectrum over a period of time).

The condition monitoring algorithm may utilize an applied logic or rule-based AI system to determine a condition of the choke valve (119). A rule-based AI system may determine a condition and a course of action given a current state, (i.e., if a current state satisfies a condition, then take a specified action). Rule-based AI methods are often referred to as expert systems; decision trees with multiple “if-then” tests are an example of such a system. “If” the system is in a certain state, “then” a certain condition is assigned and an associated action may be recommended. The condition may be, e.g., “normal,” “eroded choke,” “plugged choke,” etc. In the case of a flow velocity being too high, the action may be “reduce the choke opening.” Some implementations of logical methods do not require training datasets or training (e.g., supervised learning). In one or more embodiments, the condition monitoring algorithm includes one or more applied logical methods that analyze the operating data and assign conditions and, if necessary, trigger alarms.

Once at least one condition is determined by the verification assessment, the Data Verification Tool (206) can use the at least one condition to determine a conditioned valve position (270), which is also considered an output of the choke management system (125) as depicted in FIG. 2. The conditioned valve position (270) may be a recommended position of the choke valve (119) based on the at least one condition of the choke valve (119), as determined by the verification assessment. By way of example, a choke valve condition (250) indicating an eroded choke valve (119) may determine a conditioned valve position (270) in which the choke valve opening is made smaller in order to compensate for the erosion, resulting in a consistent flow rate. The Data Verification Tool (206) can then set the valve position of the choke valve (119) to the conditioned valve position (270) by transmitting the conditioned valve position (270) to the choke valve positioner (204). For example, the Command X (290) depicted in FIG. 2 can command the choke valve positioner (204) to adjust or set the choke valve positioner (204) to the conditioned valve position (270). To emphasize that the conditioned valve position (270) is based, at least in part, on the determined choke valve condition(s) (250), FIG. 2 depicts a dashed line that connects the output conditioned valve position (270) and choke valve condition(s) (250); as determined and output by the choke management system (125).

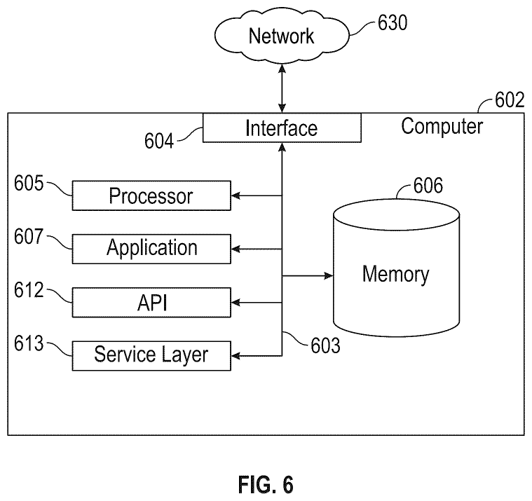

In one or more embodiments, the Data Verification Tool (206) implements a verification process as a control loop. This control loop is depicted in FIG. 7 as a flowchart (700) and is described in greater detail later in the instant disclosure.

In one or more embodiments, the Data Validation Tool (208) obtains the verified operating data and the at least one condition of the choke valve (119) from the Data Verification Tool (206) and proceeds to validate or assess the health and performance of vital equipment relating to the operation of the choke valve (119). Vital equipment may be, for example, the flow meter (127) (e.g., a MPFM including additional sensors), pressure sensors, and choke valve positioner (204). Vital equipment can also include hardware relating to the choke manifold, which distributes the fluid flow. A failure in vital equipment can cause an improper setting of the choke valve (119), which can in turn result in costly production interruptions and serious safety hazards. If a fault or failure in vital equipment is detected, the Data Validation Tool (208) can serve as an intelligent virtual backup system by providing estimated operating data that can be used for choke valve calibration and flow rate estimation until the vital equipment is repaired.

The Data Validation Tool (208) can use a second model with the operating data and the at least one condition (i.e., choke valve condition(s) (250)) determined by the Data Verification Tool (206) to perform a validation assessment. The validation assessment may analyze the second model with the operating data and the at least one condition to identify if a validity criterion is satisfied. The validity criterion may be satisfied by an affirmation that vital equipment relating to the operation of the choke valve (119) is working properly. If the validation assessment detects a failure in any vital equipment relating to the choke valve (119), the validity criterion would not be satisfied.

In response to the operating data failing to satisfy the validity criterion, the Data Validation Tool (208) can determine a plurality of choke valve backup measurements that may be used in the determination of the conditioned valve position (270). In particular, the Data Validation Tool (208) may employ the use of a Choke Management Estimation Tool (CMET) (280) to estimate the plurality of choke valve backup measurements, such as pressure values and flow rate, that would otherwise be provided by the faulty vital equipment.

Using the second model, CMET (280) may utilize multiple machine learning techniques to allow flexibility in pressure estimation and choke performance using the real-time operating data. The technique used by CMET (280) can be determined by the operating data available at the wellsite that would provide the highest accuracy and least error in estimating the choke valve backup measurements. CMET (280) can compare historic operating data, such as previous valve position and previous flow rate, with real-time operating data. The results provided by CMET (280) can be used to replace the measurements provided by vital equipment, such as a flow meter (127) implemented as a MPFM, in the case of vital equipment failure. The plurality of choke valve backup measurements can subsequently be used in the determination of the conditioned valve position (270).

CMET (280) may use one or more ML techniques to estimate the plurality of choke valve backup measurements. For example, a trained ML system may provide a mapping between upstream pressure, downstream pressure, and flow rate measurements to estimate the choke valve opening or position. This mapping may be learned with historical data pairs of the input and output to the ML method through a training process. The historical data pairs of input and output come from data previously measured in real time by the same sensors, or data measured by similar sensors at other locations and times. When new values of one or more of these alternative data types are obtained, the ML methods may predict the choke valve position from those values.

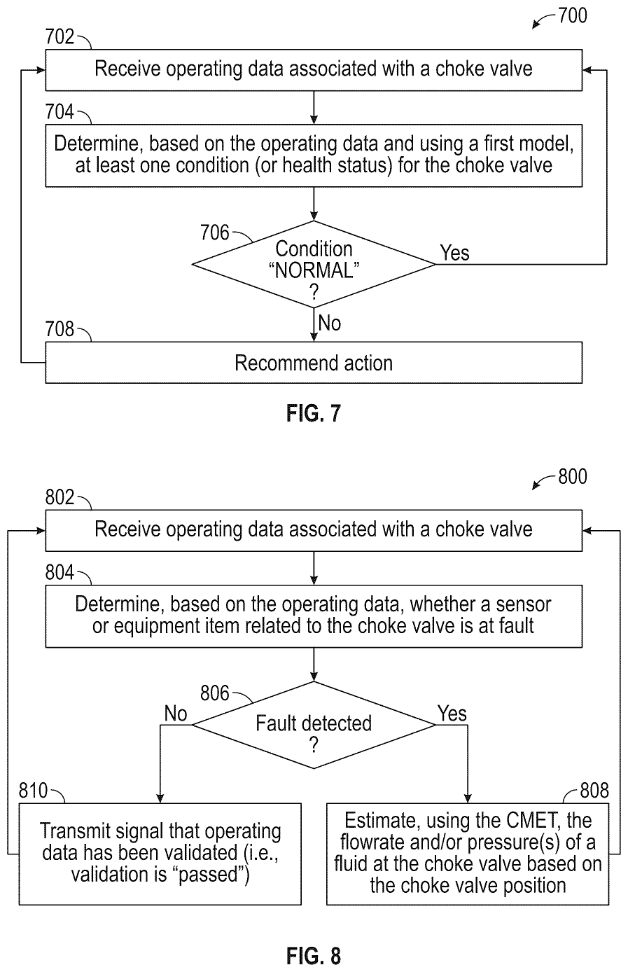

In one or more embodiments, the Data Validation Tool (208) implements a validation and estimation process as a control loop. This control loop is depicted in FIG. 8 as a flowchart (800) and is described in greater detail later in the instant disclosure.

In one or more embodiments, the Prognosis Tool (210) estimates the Remaining Life (RL) or Time-To-Failure (TTF) value of the choke valve (119); depicted in FIG. 2 as choke valve Time-To-Failure (260). The TTF value of the choke valve (119) may be achieved through the utilization of machine learning and modeling techniques that enable the prediction of future conditions of the choke valve (119). These predicted conditions can subsequently be utilized to determine the optimal timing for maintenance activities relating to the choke valve (119), which in turn minimizes downtime and maximizes operational efficiency. Additionally, knowledge of the TTF value of the choke valve (119) may allow for the strategic operation of the choke valve (119) in a manner that maximizes the lifespan of the choke valve (119). Once a TTF value is calculated, the TTF value (i.e., choke valve Time-To-Failure (260)) can be used to aid in the determination of the conditioned valve position (270). The interaction between the choke valve Time-To-Failure (260) and the conditioned valve position (270) is depicted in FIG. 2 using a dashed line that connects these outputs of the choke management system (125).

The Prognosis Tool (210) may utilize a third model to predict a TTF value of the choke valve (119). In particular, the third model can forecast a failure of the choke valve (119) using the verified real-time operating data and historical operating data, in combination with diagnostic data provided by the plurality of sensors (202). The TTF value may take a form that is suitable to the operational area that is using the choke valve (119). For example, the TTF value may be a number or a letter indicating a choke health grade, a date, a time, or a range.

In one or more embodiments, the prediction of the choke valve Time-To-Failure (260) is based on, at least in part, the acoustic signature provided by an acoustic sensor (120) associated with the choke valve (119). As described in FIG. 1A, the acoustic sensor (120) is installed downstream from the choke valve (119) and transmits the acoustic signature of the fluid flowing through the pipeline (100) as it exits the choke valve (119). The Prognosis Tool (210) can observe changes in trends or sudden spikes in the acoustic signature over a period of time. The acoustic signature may provide valuable insight into the health of the choke valve (119), as an increase in the acoustic signature, e.g., in the form of increased signal amplitude and/or power spectrum, can indicate an erosion of the choke valve (119).

In some embodiments, the third model uses a metal loss algorithm to aid in the prediction of the TTF of the choke valve (119). The metal loss algorithm can calculate the rate of material degradation due to numerous factors relating to the performance of the choke valve (119). Using input parameters such as well status (i.e., flowing, shut, etc.), pressure, temperature, velocity, and gas/oil ratio (GOR), the metal loss algorithm can predict the amount of erosion the choke valve (119) will experience. The Prognosis Tool (210) can utilize the metal loss algorithm across multiple choke valves and choke manifolds, allowing for each choke manifold to have unique performance characteristics based on the current metal loss being experienced.

Based on the upstream pressure, the downstream pressure, and the flow rate, the metal loss algorithm may calculate, in real-time, the actual available flow area of the choke valve (119). An expected available flow area may be calculated by applying the choke valve position, as reported by the choke valve positioner (204), to an expected choke valve performance curve. An amount of erosion may be determined by comparing the actual available flow area to the expected available flow area. If the actual available flow area is higher than the expected available flow area, an erosion of the choke valve (119) due to metal loss can be confirmed.

In addition to the acoustic signature and the metal loss algorithm, other real-time diagnostic parameters such as fluid velocity may be used to aid in the determination of a TTF of the choke valve (119). The velocity of the fluid in the flowline may be determined by analyzing the flowrate and the geometry of the pipeline (100). Furthermore, general information such as the manufacturer and the installation date of the choke valve (119) and choke manifold may be used to aid in the determination of a TTF of the choke valve (119).

In one or more embodiments, the Action Points Alarm Tool (212) can generate alarms or triggers and provide valuable information regarding the health and performance of the choke valve (119) based on the results of the Data Verification Tool (206), the Data Validation Tool (208), and the Prognosis Tool (210). In particular, a status report may be generated that can include the choke valve condition(s) (250), and predefined logic rules can be used to recommend an action associated with the choke valve condition(s) (250). The status report may also include the determined conditioned valve position (270) and an indication as to whether the conditioned valve position (270) has been transmitted or commanded to the choke valve positioner (204). The status report may also include the results of the validation assessment from the Data Validation Tool (208). In particular, the results of the validation assessment can indicate whether the validation criterion was satisfied. If the validation criterion was not satisfied, then an equipment failure has been detected and CMET (280) has been used to determine a plurality of choke valve backup measurements. For example, the status report may include the type of equipment failure that has been detected and the plurality of choke valve backup measurements that are being utilized to determine a conditioned valve position (270). Furthermore, the status report may include the choke valve Time-To-Failure (260), or TTF value, from the Prognosis Tool (210). The TTF value can then be used to proactively schedule maintenance and replacement of the choke valve (119).

The Action Points Alarm Tool (212) can also identify the proper response group based on the generated alarm, trigger, or condition according to the predefined logic rules. By promptly alerting the relevant response group, appropriate action can be taken to rectify any malfunctions and maintain the overall healthiness of the choke manifold. For example, in the event of an equipment failure, the Action Points Alarm Tool (212) may indicate a first response group to take the appropriate recommended action, while in the event of the prediction of future equipment failure, the Action Points Alarm Tool (212) may indicate a second response group to take the appropriate recommended action. The logic rules triggered by the alarms may also be applied to other problems to produce recommended solutions.

By way of non-limiting example, Table 1 shows a list of possible choke valve conditions and the associated recommended action.

TABLE 1
Example conditions and associated actions

| Condition | Recommended Action |
|---|---|
| Flow velocity too high | Reduce choke opening |
| Eroded choke | Increase choke opening |
| Damaged choke | Schedule replacement |
| Plugged choke | Schedule troubleshooting and intervention |

By way of non-limiting example, Table 2 shows a list of possible error codes and the associated description that can be included in the status report in the case of an equipment malfunction.

TABLE 2
Example error codes and associated descriptions

| Code | Description | Extended description |
|---|---|---|
| COMMN | Communication Problem | Communication problem |
| | | between choke manifold and |
| | | database |
| INSTR | Instrument Problem | Mechanical/electrical problem |
| | | with instruments |
| PWRFL | Power Failure | Power issue with electrical |
| | | panel |
| UNRLB | Unreliable Data | Problem due to coefficients, |
| | | registers in panel. Issues of |
| | | tag, SCADA, etc. |

Once generated, the Action Points Alarm Tool (212) may subsequently provide the status report to the display (214) for viewing.

In one or more embodiments, the display (214) receives the status report from the Action Points Alarm Tool (212) and presents the status report onto a screen for viewing. By way of non-limiting example, a display (214) can be a liquid crystal display (LCD), a plasma display, touchscreen, cathode ray tube (CRT) monitor, projector, or a mobile device.

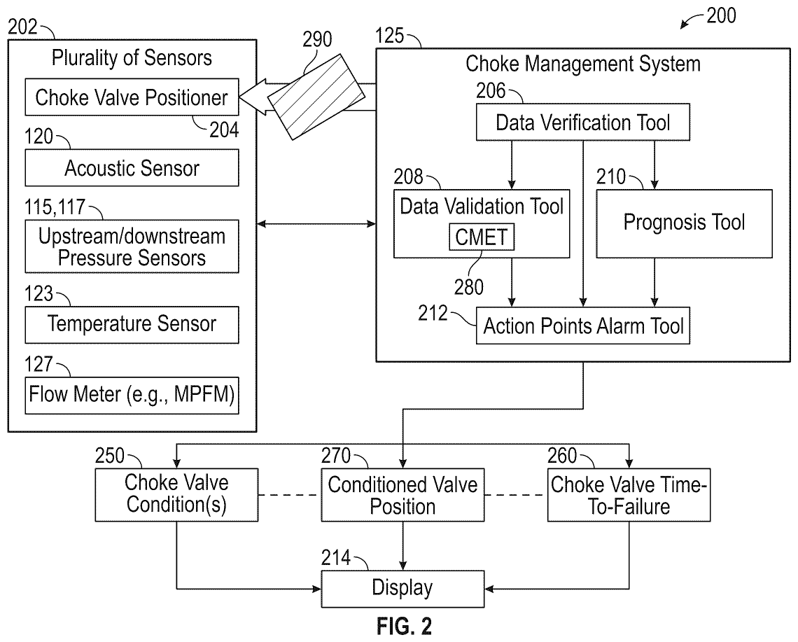

A flowchart in accordance with one or more embodiments of the disclosure is shown in FIG. 3. Specifically, FIG. 3 describes a method (300) for setting a valve position of a choke valve (119) disposed on a pipeline (100). One or more blocks in FIG. 3 may be performed by one or more components (e.g., components of the choke management system (125)) as described in FIG. 2. The method may be implemented using instructions stored on a non-transitory medium that may be executed by a computer system as shown in FIG. 6. While the various steps in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 310 real-time operating data relating to the choke valve (119) is obtained from a plurality of sensors (202) disposed on the pipeline (100). As previously described, the plurality of sensors (202) may be any number of sensor devices and equipment located along the pipeline (100) of a well. In particular, the plurality of sensors (202) can be located in proximity to the choke valve (119) and may be designed to provide operating data relating to the health and performance of the choke valve (119) in real-time. Non-limiting examples of the plurality of sensors (202) may include a choke valve positioner (204), an acoustic sensor (120), an upstream pressure sensor (115), a downstream pressure sensor (117), a temperature sensor (123), and a flow meter (127), such as a MPFM.

In one or more embodiments, the operating data may be field-derived data obtained in real-time from the plurality of sensors (202). In general, the operating data may be used to assess the current condition of the choke valve (119), identify if choke valve operations are within the high-velocity/high-erosion zone, and identify any faults within any vital equipment relating to the performance of the choke valve (119), such as the plurality of sensors (202).

In one or more embodiments, the choke valve positioner (204) may be configured to transmit the valve position of a choke valve (119) to the choke management system (125) as operating data. As will be discussed in a further step of the method, the choke valve positioner (204) may also be configured to receive a new valve position from the choke management system (125) and subsequently set the valve position of a choke valve (119) to the new position. The acoustic sensor (120) may be preferably disposed downstream from the choke valve (119) and configured to transmit an acoustic signature of a fluid flowing in the pipeline (100) to the choke management system (125) as operating data.

In one or more embodiments, the flow meter (127) is configured to transmit a flowrate of the fluid flowing in the pipeline (100) (or multiple flow rates related to the phases of the fluid in implementations using a MPFM) to the choke management system (125) as operating data. Similarly, the temperature sensor (123) can be configured to transmit a temperature of the fluid flowing in the pipeline (100) to the choke management system (125) as operating data. Furthermore, the upstream pressure sensor (115) can be configured to transmit an upstream pressure of the fluid flowing in the pipeline (100) to the choke management system (125) as operating data, and the upstream pressure sensor (117) can be configured to transmit a downstream pressure of the fluid flowing in the pipeline (100) to the choke management system (125) as operating data.

In Block 320 a verification assessment is performed by applying the operating data to a first model. The first model may be a computational model of the choke valve (119) that depicts a snapshot of the current state of the choke valve (119) based on the real-time operating data. The verification assessment can subsequently use the first model to identify at least one condition of the choke valve (119). The verification assessment may be performed by a component of the choke management system (125), such as the Data Verification Tool (206).

In one or more embodiments, the verification assessment can be designed to detect anomalies in the operating data relating to the operation of the choke valve (119). The detected anomalies may be an indication of an issue, such as faulty sensors or degradation of the choke valve (119). Using pre-defined logic, the discovered issues can be mapped to a condition of the choke valve (119), and each condition can have an associated suggested technique, or recommended action, based on the encountered issue.

The verification assessment may utilize the condition monitoring algorithm discussed with respect to FIG. 2. The condition monitoring algorithm can continuously monitor and compare the conditions derived from the operating data over a period of time. More specifically, the conditions are specific features within the operating data that exhibit changes in behavior indicating potential degradation within the choke valve system. The condition monitoring algorithm can compare the real-time operating data against established markers of faulty choke valve conditions, such as reduced valve opening at the same upstream and downstream pressure, the same flow rate, and an increased acoustic signature. Any detected anomalies may be an indication of a malfunctioning sensor or other vital equipment, or a degradation or erosion of the choke valve (119). By utilizing the advanced condition monitoring algorithm, operators can proactively identify and address current and potential faults in the system relating to the choke valve (119), which in turn can ensure optimal choke valve performance and minimize downtime due to equipment faults or failures.

The use of diagnostic sensors, such as the plurality of sensors (202), may play a pivotal role in monitoring the condition of a choke valve (119) in a fluid flow system. In one or more embodiments, the verification assessment performs a comparison between the real-time operating data provided by the plurality of sensors (202) and diagnostic operating data to aid in the determination of the at least one condition. The diagnostic operating data may be measurements or conditions that, when analyzed individually or in combination, represent established markers of faulty choke valve conditions. The diagnostic data can include previous historical operating data of the plurality of sensors (202), or the diagnostic data may be operating data obtained externally that represents trouble conditions generally relating to the plurality of sensors (202) and the choke valve (119). For example, a reduced valve opening at the same upstream and downstream pressure, the same flow rate, and an increased acoustic signature may be an indication of a faulty valve positioner or erosion in the choke valve.

The comparison of the operating data and the diagnostic data may use predefined logic rules to determine a diagnostic comparison result. The diagnostic comparison result may identify potential faulty equipment or conditions of the choke valve (119). The diagnostic result can subsequently be used to aid in the determination of the at least one condition of the choke valve (119).

In one or more preferred embodiments, the verification assessment uses the acoustic signature obtained from the acoustic sensor (120) to aid in the determination of the at least one condition. As previously described, the acoustic signature may provide valuable information regarding the amount of erosion within the choke valve (119). The acoustic sensor (120) is deployed on the pipeline (100) to capture the acoustic signature of the fluid as it flows through the choke valve (119). The acoustic signature refers to the unique sound patterns generated by the fluid flow, which can provide insights into the flow characteristics of the fluid, such as velocity, pressure, and the presence of particles or debris.

In general, an increase in the acoustic signature under normal operating conditions may be an indication of erosion in the choke valve (119) and/or the body of the choke. During the verification assessment, the acoustic signature may be compared to an acoustic threshold to determine an acoustic comparison result. The acoustic threshold may be a pre-determined signal value (e.g., amplitude value and/or power threshold) that is an indication of choke valve erosion. In some embodiments, any number of predetermined acoustic thresholds may be identified to indicate a varying amount of erosion within the choke valve (119). The field-derived acoustic signature may be compared to the predetermined acoustic thresholds, and if the acoustic signature crosses an acoustic threshold, the level of erosion associated with the acoustic threshold can indicate the level of erosion in the choke valve (119). The acoustic comparison result can be assigned a level or grade of erosion based on the highest acoustic threshold exceeded by the acoustic signature. The acoustic comparison result can subsequently be used as an aid in the determination of the at least one condition by indicating the level of erosion in the choke valve (119).

Choke valves are essential for controlling the rate of flow in oil and gas pipelines. A choke performance envelope outlines the conditions under which the choke valve can operate safely and effectively. One condition of the choke performance envelope is flow adjustment range. Flow adjustment range refers to the range within which the choke valve can adjust the flow rate. Knowledge of the flow adjustment range ensures that the choke valve can maintain the desired flow without causing turbulence or erosion of the choke valve. Another possible condition of the choke performance envelope is internal leakage. An allowable level of internal leakage can be determined, ensuring that the choke valve operates efficiently without compromising the integrity of the system.

Through real time monitoring of the choke valve, the use of the choke management system (125) ensures that well operations remain within the erosion-free zone of the choke valve performance envelope. In one or more embodiments, the verification assessment performs a comparison between the field-derived operating data and a safe flow envelope to aid in the determination of the at least one condition. A safe flow envelope, also referred to as an erosion-free zone, may be defined by the design and operational limits within which a choke valve (119) can safely function without experiencing erosion. The determination of a safe flow envelope can include factors such as fluid flow velocity, solid particle content of the fluid, and other fluid properties.

Choke valve performance can be optimized by the early detection of high-velocity fluid that has the potential to cause erosion of the choke valve (119). Monitoring of the choke fluid velocity may be a valuable tool as it enables production management to en sure that the choke operates within an erosion-free safe flow envelope, thereby extending the lifetime of the choke valve (119). Since excessive fluid flow velocity can lead to erosion of the choke valve (119), the determination of a maximum allowable fluid flow velocity, or a fluid flow velocity limit, can ensure that fluid is flowing smoothly through the choke valve (119) without causing erosion or wear to the choke valve (119). The fluid flow velocity limit may be included in the safe flow envelope of the choke valve (119).

Fluid flow velocity may be obtained from a flow measurement device, such as a Venturi meter, which measures the velocity of the fluid in the pipeline (100). The choke fluid velocity of the multi-phase fluid flowing through the choke valve (119) may be determined using operating data such as the flowrate, temperature, downstream pressure, upstream pressure, and valve position. The choke fluid velocity can be compared to the fluid flow velocity limit as defined by the safe flow envelope to determine a safe flow envelope comparison result. The safe flow envelope comparison result can subsequently be used to aid in the determination of the at least one condition.

The plurality of sensors (202) may include a Venturi meter which provides the choke fluid velocity as operating data to the choke management system (125). A Venturi meter is a type of differential pressure flow meter used to measure the flow rate of a fluid in a pipeline (100). The Venturi meter operates on the principle of Bernoulli's equation, which relates the pressure of a fluid to its velocity. Using this data in combination with known conduit geometry, the flow computer can accurately calculate the velocity of fluid passing through the choke valve (119).

Another element that can be used to determine the safe flow envelope is the content of solid particles or debris in the fluid flowing through the choke valve (119). Since the presence of solid particles in the fluid can significantly contribute to erosion, a solid particle limit can be determined that is an indicator of a minimum level of solid particles in the fluid that can cause erosion in the choke valve (119). The monitoring of a solid particle limit can ensure that only safe, acceptable levels of solid particle concentrations are flowing through the choke valve (119) to minimize abrasive wear. The solid particle limit may be included in the safe flow envelope of the choke valve (119).

A level of solid particles in the fluid may be obtained by a solids detector installed on the pipeline (100) in the vicinity of the choke valve (119). The plurality of sensors (202) may include a solids detector, such as a level measurement device or a level sensor, which provides the solid particle level as operating data to the choke management system (125). The solid particle level can be compared to the solid particle limit as defined by the safe flow envelope to determine a safe flow envelope comparison result. The safe flow envelope comparison result can subsequently be used to aid in the determination of the at least one condition.

In Block 330 a conditioned valve position is determined based on the at least one condition. The conditioned valve position may be a recommended position of the choke valve (119) based on the at least one condition of the choke valve (119), as determined by the verification assessment. By way of example, a choke valve condition indicating an eroded choke valve (119) may determine a conditioned valve position in which the choke valve opening is made smaller in order to compensate for the erosion, resulting in a consistent flow rate.

In Block 340 a validation assessment is performed, using the second model, based on the operating data and the at least one condition. The validation assessment may be performed by a component of the choke management system (125), such as the Data Validation Tool (208) discussed in FIG. 2. The validation assessment may analyze the second model with the operating data and the at least one condition to identify if a validity criterion is satisfied. The validity criterion may be satisfied by an affirmation that vital equipment relating to the operation of the choke valve (119) is working properly. If the validation assessment detects a failure in any vital equipment relating to the choke valve (119), the validity criterion would not be satisfied.

In one or more embodiments, the validation assessment performs a comparison between current, real-time operating data and original operating data. As previously described, operating data may include measurements relating to the health and performance of the choke valve (119), such as choke valve position, flow rate, acoustic signature, and upstream and downstream pressure. Original operating data, also referred to as benchmark operating data, may be operating data that was obtained at the initial life of the choke valve (119) when the choke valve (119) was put into operation. A comparison of current operating data and benchmark operating data can ensure that the choke valve (119) is operating as expected by flagging any differences between the data. Any differences detected between the current operating data and the benchmark operating data that cross a pre-determined validation threshold may result in a failure to satisfy the validity criterion.

The validation assessment may also perform a comparison of the current, real-time acoustic signature with historical acoustic signatures that were previously obtained under similar operating conditions to the current, real-time operating conditions. A comparison of the current acoustic signature and historical acoustic signatures under similar operating conditions can detect early signs of failure, enhancing the overall health monitoring of the choke valve (119). Any differences detected in the comparison between the current acoustic signature and the historical acoustic signatures that cross a pre-determined validation threshold may result in a failure to satisfy the validity criterion.

The validation assessment can validate or assess the health and performance of vital equipment relating to the operation of the choke valve (119) based on the field-derived operating data. A failure in vital equipment can cause an improper setting of the choke valve (119), which can in turn result in costly production interruptions and serious safety hazards. If a fault or failure in vital equipment is detected (i.e., the validity criterion is not satisfied), a plurality of choke valve backup measurements may be determined. The plurality of choke valve backup measurements may be used in place of the field-derived operating data to subsequently aid in the determination of the conditioned valve position.

In one or more embodiments, the plurality of choke valve backup measurements may be determined by an algorithm such as CMET (280), as previously described in relation to FIG. 2. CMET (280) can use the second model to employ multiple ML techniques to estimate the plurality of choke valve backup measurements, such as pressure values and flow rate, that would otherwise be provided by the faulty vital equipment as operating data. CMET (280) uses real-time numerical parameters such as upstream wellhead pressure, upstream wellhead temperature, downstream wellhead pressure, velocity, and other operating data in combination with historical data measured under similar environments. Operators can select the technique that best suits their field, ensuring the highest accuracy based on the available operating data and minimizing errors.

In Block 350 a failure of the choke valve (119) is predicted. In one or more embodiments, the predicted failure is a Time-To-Failure (TTF) determined using a third model. Predicting the TTF of the choke valve (119) may be done by a component of the choke management system (125), such as the Prognosis Tool (210) discussed in FIG. 2. The third model can forecast a failure of the choke valve (119) using the real-time operating data and historical operating data, in combination with diagnostic data provided by the plurality of sensors (202). The result of the prediction is a TTF value, which may be used to aid in the determination of the conditioned valve position.

As previously described, the third model may predict the TTF value of the choke valve (119) using ML and modeling techniques that enable the prediction of future conditions of the choke valve (119). These predicted conditions can subsequently be utilized to determine the optimal timing for maintenance activities relating to the choke valve (119), which in turn minimizes downtime and maximizes operational efficiency. Additionally, knowledge of the TTF value of the choke valve (119) may allow for the strategic operation of the choke valve (119) in a manner that maximizes the lifespan of the choke valve (119).

In a preferred embodiment, the acoustic signature provided by the acoustic sensor (120) is used to predict the TTF of the choke valve (119). As described in FIG. 1A, the acoustic sensor (120) may be installed downstream from the choke valve (119) and transmit the acoustic signature of the fluid flowing through the pipeline (100) as it exits the choke valve (119). The acoustic signature may provide valuable insight into the health of the choke valve (119) by observing changes in trends or sudden spikes in the acoustic signature over a period of time. For example, an increase in the acoustic signature can indicate an erosion of the choke valve (119).

In one or more embodiments, the third model may utilize a metal loss algorithm based on, at least in part, the acoustic signature to predict the TTF value. The metal loss algorithm can predict the rate at which metal components will deteriorate over time. Through observation of the operating data over time, patterns and trends may indicate an erosion of the choke valve (119), which allows operators to take preventive action to avoid costly downtime and safety risks. Additionally, the choke valve (119) may be strategically positioned to account for the detected erosion in the choke valve (119), allowing for more efficient operation and longer lifetime of the choke valve (119).

The metal loss algorithm can calculate the rate of material degradation due to numerous factors relating to the performance of the choke valve (119). Using input parameters such as well status (i.e., flowing, shut), pressure, temperature, velocity, and gas/oil ratio (GOR), the metal loss algorithm can predict the amount of erosion the choke valve (119) will experience. Based on the upstream pressure, the downstream pressure, and the flow rate, the metal loss algorithm may calculate, in real-time, the actual available flow area of the choke valve (119). An expected available flow area may be calculated by applying the choke valve position, as reported by the choke valve positioner (204), to an expected choke valve performance curve. An amount of erosion may be determined by comparing the actual available flow area to the expected available flow area. If the actual available flow area is higher than the expected available flow area, an erosion of the choke valve (119) due to metal loss can be confirmed.

The terms erosive wear and erosion may be defined as material loss resulting from impact of solid/sand particles on the surface of a material. Thus, the rate of erosion may be based on fluid flow velocity, material properties of the choke valve (119), and impact angles of the fluid. Simply put, the following equation can be used to estimate a rate of erosion in the choke valve (119):

Erosion~K*vⁿ (1)

where K is a material constant, v is the velocity of the fluid, and n is a velocity exponent, generally between 2 and 3.5 for metals. The material “constants” K and n depend upon the properties of the material in the choke, such as hardness, and may be determined by experimental investigation. Further information regarding EQ. 1 can be found in DNV-RP-O501 “Managing sand production and erosion.”

Using the upstream pressure and the downstream pressure reported by the pressure sensors, the velocity of the fluid v can be calculated from Bernoulli's equation as follows:

$${P}_{1} + \frac{1}{2} p {v}_{1}^{2} + {pgh}_{1} = {P}_{2} + \frac{1}{2} p {v}_{2}^{2} + {pgh}_{2} \qquad ( 2 )$$

where P is the absolute pressure, p is the fluid density, h is the height above some reference point, g is the acceleration due to gravity, and the subscripts 1 and 2 refer to any two points along the path that the fluid follows.

Using the gas flow rate obtained by a flow meter (127), such as an MFPM, the expected available flow area within the choke valve (119) can be calculated as follows:

$$v = \frac{{Q}_{gas}}{expected available flow area} ↔ expected available flow area = \frac{{Q}_{g a s}}{v} \qquad ( 3 )$$

where Q_{gas} is the volumetric flow rate of gas in the choke valve (119).

In Block 360 the valve position is set to the conditioned valve position using the choke valve positioner (204). The valve position may be set automatically or electronically by a transmission (e.g., Command X (290)) of the conditioned valve position to the choke valve positioner (204), or the choke valve position may be set manually by an operator according to the conditioned valve position. Accordingly, the choke valve (119) can be manually or automatically controlled without departing from the scope of the disclosure herein.

In Block 370 a status report is generated that includes the at least one condition and a recommended action associated with the at least one condition. The status report may be generated by a component of the choke management system (125), such as the Action Points Alarm Tool (212) discussed in FIG. 2. Predefined logic rules can be used to recommend an action associated with the at least one condition.

In one or more embodiments, the status report can include the result of the validation assessment. In particular, the results of the validation assessment can indicate whether the validation criterion was satisfied. If the validation criterion was not satisfied, then an equipment failure has been detected and CMET (280) has been used to determine a plurality of choke valve backup measurements. For example, the status report may include the type of equipment failure that has been detected and the plurality of choke valve backup measurements that are being utilized to determine a conditioned valve position. Furthermore, the status report may include the TTF value. The TTF value can then be used to proactively schedule maintenance and replacement of the choke valve (119).

In one or more embodiments, the status report can identify the proper response group based on the generated alarm, trigger, or condition according to the predefined logic rules. By promptly alerting the relevant response group, appropriate action can be taken to rectify any malfunctions and maintain the overall healthiness of the choke manifold. For example, in the event of an equipment failure, the status report may indicate a first response group to take the appropriate recommended action, while in the event of the prediction of future equipment failure, the status report may indicate a second response group to take the appropriate recommended action. The logic rules triggered by the alarms may also be applied to other problems to produce recommended solutions.

In Block 380 the status report, and other information such as operating data, is received by a display (214). The choke management system (125) can transmit the status report to a display (214).

In Block 390 the status report is presented or displayed on the display (214). Once received by the display (214), an operator can view the status report. Based on the alarms, triggers, and conditions reported in the status report, appropriate actions can be taken.

The integration of Machine Learning (ML) models in the choke management system (125) can enable a comprehensive approach to monitoring and predicting the performance and health of the choke valve (119) and choke manifold. As previously described, in one or more embodiments, the first model, the second model, and/or the third model are ML models, or are, at least in part, composed of ML models. Machine learning, broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein, however, one skilled in the art will recognize that the concepts and methods detailed hereafter are not limited by this choice of nomenclature.

ML model types may include, but are not limited to, neural networks, random forests, generalized linear models, and Bayesian regression. Further, as defined herein, ML may include algorithmic search methods and optimization methods such as a line search or the genetic algorithm. ML model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameter surrounding a model is referred to as selecting the model “architecture.” Generally, multiple model types and associated hyperparameters are tested and the model type and hyperparameters that yield the greatest predictive performance on a hold-out set of data is selected. Consequently, in many circumstances, a machine-learned model may be specified by indicating its type and associated hyperparameters.

In accordance with one or more embodiments, one or more machine learning models described herein are based on, or may be understood as, a specialized artificial neural network (NN). Thus, a brief introduction to a NN is provided herein. However, it is noted that there are many variations and architectures of NNs networks. Therefore, one with ordinary skill in the art will recognize that any variation of the NN (or any other machine-learned model) may be employed without departing from the scope of this disclosure. Further, it is emphasized that the following discussion of a NN should not be considered limiting.

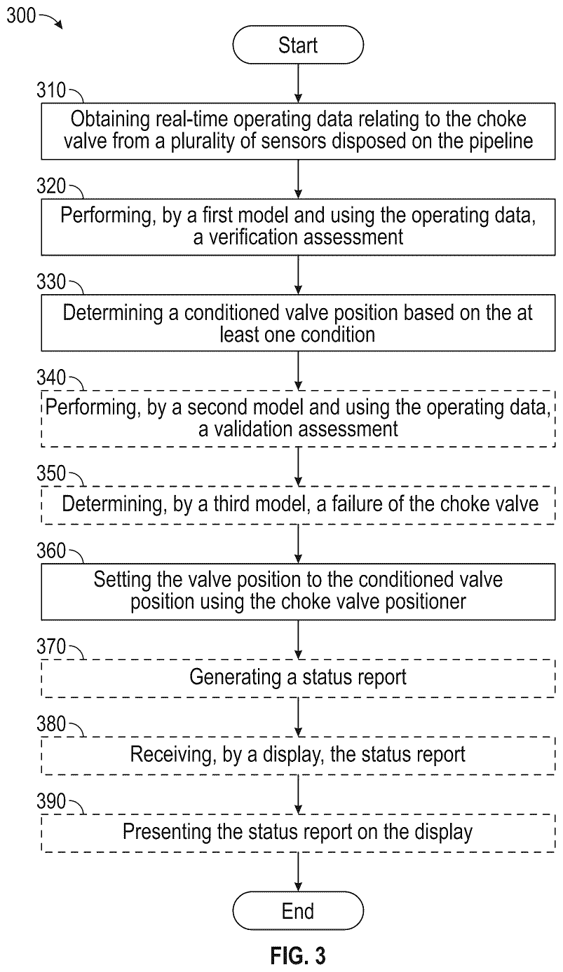

In one or more embodiments, the machine-learned model type of the first model, the second model, and/or the third model is a neural network. A diagram of a neural network is shown in FIG. 4. At a high level, a neural network (400) may be graphically depicted as being composed of nodes (402), where here any circle represents a node, and edges (404), shown here as directed lines. The nodes (402) may be grouped to form layers (405). FIG. 4 displays four layers (408, 410, 412, 414) of nodes (402) where the nodes (402) are grouped into columns, however, the grouping need not be as shown in FIG. 4. The edges (404) connect the nodes (402). Edges (404) may connect, or not connect, to any node(s) (402) regardless of which layer (405) the node(s) (402) is in. That is, the nodes (402) may be sparsely and residually connected. A neural network (400) will have at least two layers (405), where the first layer (408) is considered the “input layer” and the last layer (414) is the “output layer.” Any intermediate layer (410, 412) is usually described as a “hidden layer.” A neural network (400) may have zero or more hidden layers (410, 412) and a neural network (400) with at least one hidden layer (410, 412) may be described as a “deep” neural network or as a “deep learning method.” In general, a neural network (400) may have more than one node (402) in the output layer (414). In this case the neural network (400) may be referred to as a “multi-target” or “multi-output” network.

Nodes (402) and edges (404) carry additional associations. Namely, every edge is associated with a numerical value. The edge numerical values, or even the edges (404) themselves, are often referred to as “weights” or “parameters.” While training a neural network (400), numerical values are assigned to each edge (404). Additionally, every node (402) is associated with a numerical variable and an activation function. Activation functions are not limited to any functional class, but traditionally follow the form

A=ƒ(Σ_{i∈(incoming)}[(node value)ᵢ(edge value)ᵢ]), (4)

where i is an index that spans the set of “incoming” nodes (402) and edges (404) and ƒ is a user-defined function. Incoming nodes (402) are those that, when viewed as a graph (as in FIG. 4), have directed arrows that point to the node (402) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (402) in a neural network (400) may have a different associated activation function. Often, as a shorthand, activation functions are described by the function ƒ by which it is composed. That is, an activation function composed of a linear function ƒ may simply be referred to as a linear activation function without undue ambiguity.

When the neural network (400) receives an input, the input is propagated through the network according to the activation functions and incoming node (402) values and edge (404) values to compute a value for each node (402). That is, the numerical value for each node (402) may change for each received input. Occasionally, nodes (402) are assigned fixed numerical values, such as the value of 1, that are not affected by the input or altered according to edge (404) values and activation functions. Fixed nodes (402) are often referred to as “biases” or “bias nodes” (405), displayed in FIG. 4 with a dashed circle.

In some implementations, the neural network (400) may contain specialized layers (405), such as a normalization layer, or additional connection procedures, like concatenation. One skilled in the art will appreciate that these alterations do not exceed the scope of this disclosure.

As noted, the training procedure for the neural network (400) comprises assigning values to the edges (404). To begin training the edges (404) are assigned initial values. These values may be assigned randomly, assigned according to a prescribed distribution, assigned manually, or by some other assignment mechanism. Once edge (404) values have been initialized, the neural network (400) may act as a function, such that it may receive inputs and produce an output. As such, at least one input is propagated through the neural network (400) to produce an output. Generally, a training dataset is provided to the neural network for training. A given training data set will be composed of inputs and associated target(s), where the target(s) represent the “ground truth,” or the otherwise desired output. The neural network (400) output is compared to the associated input data target(s). The comparison of the neural network (400) output to the target(s) is typically performed by a so-called “loss function”; although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (400) output and the associated target(s). The loss function may also be constructed to impose additional constraints on the values assumed by the edges (404), for example, by adding a penalty term, which may be physics-based, or a regularization term. Generally, the goal of a training procedure is to alter the edge (404) values to promote similarity between the neural network (400) output and associated target(s) over the data set. Thus, the loss function is used to guide changes made to the edge (404) values, typically through a process called “backpropagation.”

While a full review of the backpropagation process exceeds the scope of this disclosure, a brief summary is provided. Backpropagation consists of computing the gradient of the loss function over the edge (404) values. The gradient indicates the direction of change in the edge (404) values that results in the greatest change to the loss function. Because the gradient is local to the current edge (404) values, the edge (404) values are typically updated by a “step” in the direction indicated by the gradient. The step size is often referred to as the “learning rate” and need not remain fixed during the training process. Additionally, the step size and direction may be informed by previously seen edge (404) values or previously computed gradients. Such methods for determining the step direction are usually referred to as “momentum” based methods.

Once the edge (404) values have been updated, or altered from their initial values, through a backpropagation step, the neural network (400) will likely produce different outputs. Thus, the procedure of propagating at least one input through the neural network (400), comparing the neural network (400) output with the associated target(s) with a loss function, computing the gradient of the loss function with respect to the edge (404) values, and updating the edge (404) values with a step guided by the gradient, is repeated until a termination criterion is reached. Common termination criteria are: reaching a fixed number of edge (404) updates, otherwise known as an iteration counter; a diminishing learning rate; noting no appreciable change in the loss function between iterations; reaching a specified performance metric as evaluated on the data or a separate hold-out dataset. Once the termination criterion is satisfied, and the edge (404) values are no longer intended to be altered, the neural network (400) is said to be “trained.”

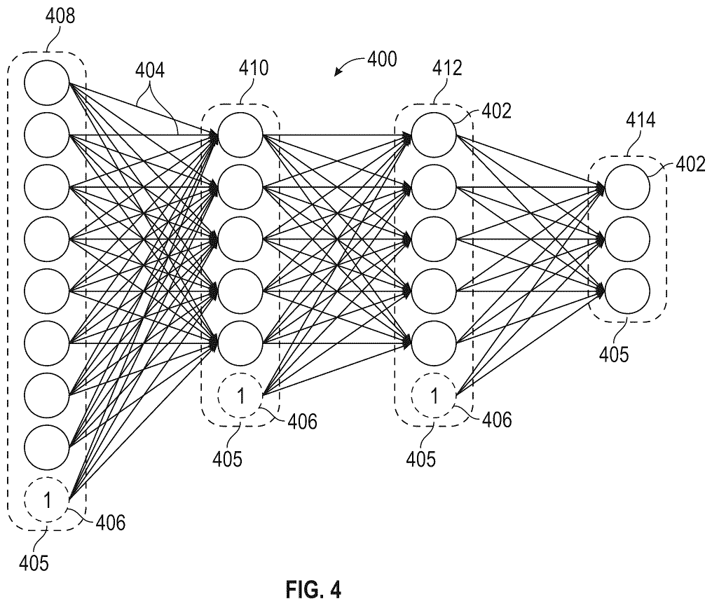

FIG. 5 depicts the general process of selecting and training a machine-learned model, in accordance with one or more embodiments. The process shown in FIG. 5 may be applied to train the first model, the second model, and/or the third model.

To start, as shown in Block 502, modelling data is received. The modelling data consists of input and target pairs. For example, to train the first model, the second model, and/or the third model, an input and target pair may consist of historic operating data and the associated condition of the choke valve (119) at the time when the historic operating data was collected. In accordance with one or more embodiments, the historic operating data may include upstream pressure, downstream pressure, temperature, flow rate, and acoustic signature. In one or more embodiments, the associated state or condition of the choke valve (119) at the time when the historic operating data was collected can be determined manually by an operator.

In general, the modelling data used to train the first model, the second model, and/or the third model for monitoring and predicting the performance and health of choke manifolds is diverse and sourced from multiple avenues to ensure comprehensive analysis. Ensuring the quality and relevance of the modelling data is essential for the accurate functioning of the models.

For example, modelling data can be sourced from manufacturer design data. That is, prior to installation, the choke manufacturer provides, as part of the sizing calculation, trim noise at minimum, normal, and maximum flow process conditions. Design data may also include valve geometry, material properties, corrosion resistance, computational fluid dynamics through simulated flow and pressure profiles under extreme conditions. Design data may be used as a benchmark, or benchmark operating data, during the determination of a condition of the choke valve (119) or choke manifold, and in the prediction of the TTF of the choke valve (119) or choke manifold.

In addition to design data, historical performance data may be used as modelling data, as previously described. In particular, historical performance data may include past records of the performance of the choke manifold, such as flow rates, pressures, temperatures, and choke valve responses to upstream and downstream pressure changes with time based series of flow rates to detect anomalies during the valve open/close state. Accordingly, historical performance data can be crucial for establishing baseline performance metrics and identifying trends over time.

Another source of modelling data may be the real-time operating data obtained from the plurality of sensors (202). Current data from sensors monitoring the choke valve (119) and choke manifold can be invaluable for real-time analysis. Parameters such as flow velocity, pressure, temperature, and acoustic signals or vibration data are continuously collected to assess the current state of the choke manifold.

In other words, in general, the modelling data consists of the expected input and desired output for the machine-learned model. In accordance with one or more embodiments, the modelling data is acquired from one or more existing wells or from previously collected historical well data. Returning to FIG. 5, in one or more embodiments, the modelling data is preprocessed as depicted by Block 504. Preprocessing, at a minimum, comprises altering the modelling data so that it is suitable for use with machine-learned models. For example, numericizing categorical data or removing data entries with missing values. Other typical preprocessing methods are normalization and imputation. Information surrounding the preprocessing steps is saved for potential later use. For example, if normalization is performed then a computed mean vector and variance vector are retained. This allows future modelling data to be preprocessed identically. Values computed and retained during preprocessing are referred to herein as preprocessing parameters. One with ordinary skill in the art will recognize that a myriad of preprocessing methods beyond numericalization, removal of modelling data entries with missing values, normalization, and imputation exist. Descriptions of a select few preprocessing methods herein do not impose a limitation on the preprocessing steps encompassed by this disclosure.

As shown in Block 506, the modelling data is split into training, validation, and test sets. In some embodiments, the validation and test set may be the same such that the data is effectively only split into two distinct sets. In some instances, Block 506 may be performed before Block 504. In this case, it is common to determine the preprocessing parameters, if any, using the training set and then to apply these parameters to the validation and test sets.

In Block 508, one or more machine-learned model types and associated architectures are selected. For example, in one or more embodiments, the first model, the second model, and/or the third model are composed of more than one machine-learned models. In this case, each of the one or more machine-learned models are selected. For each machine-learned model, once the machine-learned model type and hyperparameters have been selected, the machine-learned model is trained using the training set of the modelling data according to Block 510. Common training techniques, such as early stopping, adaptive or scheduled learning rates, and cross-validation may be used during training without departing from the scope of this disclosure.

During training, or once trained, the performance of the trained machine-learned model is evaluated using the validation set as depicted in Block 512. Recall, that in some instances, the validation set and test set are the same. Generally, performance is measured using a function which compares the predictions of the trained machine-learned model to the given targets. A commonly used comparison function is the mean-squared-error function, which quantifies the difference between the predicted value and the actual value when the predicted value is continuous, however, one with ordinary skill in the art will appreciate that many more comparison functions exist and may be used without limiting the scope of the present disclosure.

Block 514 represents a decision: if the trained machine-learned model performance, as measured by a comparison function on the validation set (Block 512), is not suitable, the machine-learned model architecture may be altered (i.e., return to Block 508) and the training process is repeated. There are many mays to alter the machine-learned model architecture in search of suitable trained machine-learned model performance. These include, but are not limited to: selecting a new architecture from a previously defined set; randomly perturbing or randomly selecting new hyperparameters; using a grid search over the available hyperparameters; and intelligently altering hyperparameters based on the observed performance of previous models (e.g., a Bayesian hyperparameter search). Once suitable performance is achieved, the training procedure is complete and the generalization error of the trained machine-learned model(s) is estimated according to Block 516.

Generalization error is an indication of the trained machine-learned model's performance on new, or un-seen data. Typically, the generalization error is estimated using the comparison function, as previously described, using the modelling data that was partitioned into the test set.

As depicted in Block 518, the trained machine-learned model(s) is used “in production”-which means the trained machine-learned model(s) is used to process a received input without having a paired target for comparison. It is emphasized that the inputs received in the production setting, as well as for the validation and test sets, are preprocessed identically to the manner defined in Block 504 as denoted by the connection (522), represented as a dashed line in FIG. 5, between Blocks 518 and 504.

In accordance with one or more embodiments, the performance of the trained machine-learned model(s) is continuously monitored in the production setting. If model performance is suspected to be degrading, as observed through in-production performance metrics, the model may be updated. An update may include retraining the model, by reverting to Block 508, with the newly acquired modelling data from the in-production recorded values appended to the training data. An update may also include returning to Block 504 to recalculate any preprocessing parameters, again, after appending the newly acquired modelling data to the existing modelling data.

While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Embodiments of the present disclosure may be implemented on a computer system. FIG. 6 is a block diagram of a computer system (602) used to provide computational functionalities associated with described algorithms, methods, functions, processes, flows, and procedures as described in the instant disclosure, according to one or more embodiments. The illustrated computer (602) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts. The illustrated computer (602) may also encompass custom-designed neural networks (500), as well as graphics processing units (GPUs).

Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or another suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604) includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). The memory may be a non-transitory computer readable medium. For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing computer (602), wherein each computer (602) communicates over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

Turning to FIG. 7, FIG. 7 depicts a flowchart (700) in accordance with one or more embodiments. The flowchart (700) implements a control loop that, in some implementations, is executed by, or describes the function of, the Data Verification Tool (206). The flowchart (700) begins in Block 702 where the operating data associated with a choke valve is received from a pipeline. As previously described, the operating data can include pressure, temperature, flow rate(s), choke valve position, and acoustic measurements from the pipeline in the vicinity of the choke valve using one or more dedicated sensors. In Block 704 the operating data is used in conjunction with a first model to determine at least one condition (i.e., choke valve condition(s) (250)) for the choke valve. In one more embodiments, the condition (or at least one condition) assigns a category or class to the choke valve indicative of the health status of the choke valve. In these embodiments, the classes include a “NORMAL” class indicative of a healthy or well-functioning choke valve and at least one other class such as “FAULTY,” “ERODED,” and/or “PLUGGED.” In some instances, more than one condition can be determined for a choke valve such as the conditions “FAULTY” and “ERODED.” For this reason, it is said that at least one condition is determined for the choke valve to emphasize that some conditions (or classes or categorizations) are not mutually exclusive.

Continuing with FIG. 7, Block 706 represents a decision based on the determined at least one condition (or health status) of the choke valve. If the condition of the choke valve is determined to be “NORMAL” (or an equivalent class or category as long as it is predefined as such) then execution of the flowchart (700) returns to Block 702 where new operating data is acquired and the control loop is completed. If, however, the condition of the choke valve is determined to be something other than “NORMAL” (or equivalent class), then the flowchart (700) proceeds to Block 708. In Block 708 an action is recommended based on the determined at least one condition for the choke valve. Examples of conditions and associated recommended actions are depicted in Table 1. That is, Table 1 relates a given condition to a given recommended action. The recommended action can be included in an alarm and/or in a status report that is provided to the user, for example, using a display. After Block 708, the flowchart (700) returns to Block 702 completing the control loop. In some implementations, the flowchart (700) may pause execution between Blocks 708 and 702 until receiving confirmation, or a signal, from a user that the recommended action has been implemented.

Turning to FIG. 8, FIG. 8 depicts a flowchart (800) in accordance with one or more embodiments. The flowchart (800) implements a control loop that, in some implementations, is executed by, or describes the function of, the Data Validation Tool (208). The flowchart (800) begins in Block 802 where the operating data associated with a choke valve is received from a pipeline. As previously described, the operating data can include pressure, temperature, flow rate(s), choke valve position, and acoustic measurements from the pipeline in the vicinity of the choke valve using one or more dedicated sensors. In Block 804 the operating data (and other data originating from the sensors such as diagnostics data) is used to determine whether a sensor, or one of its components, is at fault. For simplicity, a sensor or a component of a sensor (if applicable) can be referred to as an equipment item. Block 806 represents a decision. If, in Block 806, it is determined that an equipment item is at fault (i.e., in a state of fault or in a faulty state), then the flowchart (800) proceeds to Block 808. In some embodiments, determination of a fault of a sensor is determined using diagnostic data from the sensor and/or a comparison of the measurement of the sensor (or sensor value) to historical measurements of the sensor in view of the remaining operating data (and diagnostics data, if available). For example, an anomaly detection method can be used to determine whether a sensor value is anomalous and indicative of a faulty sensor. In Block 808, a Choke Management Estimation Tool (CMET) (280) is used to estimate a flowrate and/or pressure for the fluid at the choke valve based on the choke valve position. Thus, the choke management system (125) can be used to determine optimal choke valve position(s) even in the event of equipment failure. If, in Block 806, no faults are detected then the flowchart (800) proceeds to Block 810. In Block 810, a signal is transmitted (or otherwise displayed) to indicate that the operating data- and thus the sensors—have been validated. After either Block 808 or Block 810, the execution of the flowchart (800) returns to Block 802; thus, completing the control loop.

Embodiments of the instant disclosure provide several advantages for the operation of oil and gas pipelines and/or pipeline networks. For example, the choke management system (125) is vendor and manufacturer-independent. Thus, the system can be easily integrated into existing well operations regardless of the manufacturer or vendor of the equipment in use. Vendors and manufacturers often use different logic, algorithms, and complexity in equipment to obtain measurements, trigger alarms, etc. As the choke management system (125) is vendor agnostic, the system can merge the logic from all equipment into a unified platform.

Additionally, embodiments of the choke management system (125) can be a field-wide choke management system that is applied to multiple choke valves, creating a dashboard or control hub for a pipeline network or a system of pipelines. In particular, embodiments of the choke management system (125) can remotely monitor the health of all choke valves in a pipeline network in real-time. An in-house analytics system, such as one or more central monitoring systems, can include various modules. In some embodiments, the analytics system can include modules such as a Field Overview Module, a Choke Manifold Overview Module, a Data Management Module, and an Alarm Management Module. Such modules can support solutions that cover infrastructure requirements, visualization requirements, service optimization, and prediction. For example, service optimization can refer to achieving a same quality level of service while reducing the number of field visits, where the level of service is greater than a predefined threshold.

Furthermore, the choke management system (125) aligns with the principles of the Fourth Industrial Revolution (4IR) by integrating technological features such as automated real-time decision making, AI/ML, high capacity connectivity, and self-monitoring. The system is a unified platform to provide continuous, real-time pressure readings utilizing choke manifold, prediction, and verification tools to verify the health and performance of the choke manifold. The system further provides recommended actions for the short term and long term, thus increasing the lifetime of equipment, increasing operator safety by minimizing exposure to H2S and CO2 during replacement operations, and reducing costs and downtime by scheduling maintenance in an efficient manner.

Moreover, embodiments of the choke management system (125) can monitor the effects of downhole pressure during fracturing operations, providing data to aid in the optimization of fracture length. Additionally, CMET (280) can be used as a standalone solution or in combination with a choke manifold as a back-up system.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for setting a valve position of a choke valve disposed on a pipeline, the method comprising:
obtaining real-time operating data relating to the choke valve from a plurality of sensors disposed on the pipeline,
wherein the plurality of sensors comprises:
a choke valve positioner configured to transmit and set the valve position, and
an acoustic sensor disposed downstream from the choke valve configured to transmit an acoustic signature of a fluid flowing in the pipeline,
wherein the operating data comprises the valve position and the acoustic signature;
performing, by a first model using the operating data, a verification assessment,
wherein the verification assessment identifies at least one condition of the choke valve;
determining a conditioned valve position based on the at least one condition; and
setting the valve position to the conditioned valve position using the choke valve positioner.

2. The method of claim 1, further comprising:
generating a status report comprising the at least one condition and a recommended action associated with the at least one condition;
receiving, by a display, the status report; and
presenting, to an operator, the status report on the display.

3. The method of claim 1, wherein performing the verification assessment further comprises:
comparing the acoustic signature to an acoustic threshold to determine an acoustic comparison result; and
identifying the at least one condition using the acoustic comparison result.

4. The method of claim 1,
wherein the plurality of sensors further comprises:
a flow sensor configured to transmit a flowrate of the fluid flowing in the pipeline,
a temperature sensor configured to transmit a temperature of the fluid flowing in the pipeline,
an upstream pressure sensor disposed upstream from the choke valve and configured to transmit an upstream pressure of the fluid flowing in the pipeline, and
a downstream pressure sensor disposed downstream from the choke valve and configured to transmit a downstream pressure of the fluid flowing in the pipeline,
wherein the operating data further comprises the flowrate, the temperature, the upstream pressure, and the downstream pressure.

5. The method of claim 1, wherein performing the verification assessment further comprises:
obtaining a safe flow envelope of the choke valve, wherein the safe flow envelope comprises a fluid flow velocity limit and a solid particle limit;
obtaining a choke fluid velocity from a velocity measurement device disposed on the pipeline;
obtaining a solid particle level from a solids detector disposed on the pipeline;
comparing the choke fluid velocity and the solid particle level to the fluid flow velocity limit and the solid particle limit to determine a safe flow envelope comparison result; and
identifying the at least one condition using the safe flow envelope comparison result.

6. The method of claim 1, wherein performing the verification assessment further comprises:
obtaining diagnostic data relating to the plurality of sensors, wherein the diagnostic data comprises faulty operating values of the plurality of sensors;
comparing the operating data with the diagnostic data to determine a diagnostic comparison result; and
identifying the at least one condition using the diagnostic comparison result.

7. The method of claim 1, wherein the first model comprises a first trained machine learning (ML) model, previously trained using historical operating data.

8. The method of claim 2, further comprising:
performing, by a second model and using the operating data, a validation assessment,
wherein the validation assessment identifies whether the operating data satisfies a validity criterion for the choke valve; and
determining, by the second model in response to the operating data failing to satisfy the validity criterion, a plurality of choke valve backup measurements,
wherein determining the conditioned valve position is further based on the plurality of choke valve backup measurements,
wherein the status report further comprises a result of the validation assessment.

9. The method of claim 2, further comprising:
determining, by a third model, a failure of the choke valve,
wherein the third model utilizes, at least in part, the acoustic signature to predict a time-to-failure (TTF) value of the choke valve,
wherein determining the conditioned valve position further uses the TTF value;
wherein the status report further comprises the TTF value.

10. The method of claim 9, wherein the third model further utilizes a metal loss algorithm to determine the TTF value.

11. The method of claim 8, wherein the second model comprises a second trained ML model, previously trained using historical operating data.

12. A system, comprising:
a choke valve disposed on a pipeline;
a plurality of sensors disposed on the pipeline, wherein the plurality of sensors comprises:
a choke valve positioner configured to transmit and set a valve position for the choke valve, and
an acoustic sensor disposed downstream from the choke valve configured to transmit an acoustic signature of a fluid flowing in the pipeline;
a data verification tool, configured to:
obtain real-time operating data relating to the choke valve from the plurality of sensors, wherein the operating data comprises the valve position and the acoustic signature;
perform, by a first model and using the operating data, a verification assessment,
wherein the verification assessment identifies at least one condition of the choke valve;
determine a conditioned valve position based on the at least one condition; and
set the valve position to the conditioned valve position using the choke valve positioner;
an action points alarm tool, configured to:
generate a status report comprising the at least one condition and a recommended action associated with the at least one condition; and
a display configured to:
receive the status report from the action points alarm tool; and
present the status report to an operator.

13. The system of claim 12, wherein as part of performing the verification assessment, the data verification tool is further configured to:
compare the acoustic signature to an acoustic threshold to determine an acoustic comparison result; and
identify the at least one condition using the acoustic comparison result.

14. The system of claim 12,
wherein the plurality of sensors further comprises:
a flow sensor configured to transmit a flowrate of the fluid flowing in the pipeline,
a temperature sensor configured to transmit a temperature of the fluid flowing in the pipeline,
an upstream pressure sensor disposed upstream from the choke valve and configured to transmit an upstream pressure of the fluid flowing in the pipeline, and
a downstream pressure sensor disposed downstream from the choke valve and configured to transmit a downstream pressure of the fluid flowing in the pipeline,
wherein the operating data further comprises the flowrate, the temperature, the upstream pressure, and the downstream pressure.

15. The system of claim 12, wherein as part of performing the verification assessment, the data verification tool is further configured to:
obtain a safe flow envelope of the choke valve, wherein the safe flow envelope comprises a fluid flow velocity limit and a solid particle limit;
obtain a choke fluid velocity from a velocity measurement device disposed on the pipeline;
obtain a solid particle level from a solids detector disposed on the pipeline;
compare the choke fluid velocity and the solid particle level to the fluid flow velocity limit and the solid particle limit to determine a safe flow envelope comparison result; and
identify the at least one condition using the safe flow envelope comparison result.

16. The system of claim 12, wherein as part of performing the verification assessment, the data verification tool is further configured to:
obtain diagnostic data relating to the plurality of sensors, wherein the diagnostic data comprises faulty operating values of the plurality of sensors;
compare the operating data with the diagnostic data to determine a diagnostic comparison result; and
identify the at least one condition using the diagnostic comparison result.

17. The system of claim 12, wherein the first model comprises a first trained ML model, previously trained using historical operating data.

18. The system of claim 12, further comprising:
a data validation tool, configured to:
perform, by a second model and using the operating data, a validation assessment,
wherein the validation assessment identifies whether the operating data satisfies a validity criterion for the choke valve; and
determine, by the second model in response to the operating data failing to satisfy the validity criterion, a plurality of choke valve backup measurements,
wherein determining the conditioned valve position further uses the plurality of choke valve backup measurements;
wherein the status report further comprises a result of the validation assessment.

19. The system of claim 12, further comprising:
a prognosis tool, configured to:
determine, by a third model, a failure of the choke valve,
wherein the third model utilizes, at least in part, the acoustic signature to predict a time-to-failure (TTF) value of the choke valve, and
wherein determining the conditioned valve position further uses the TTF value;
wherein the status report further comprises the TTF value.

20. The system of claim 19, wherein the third model further utilizes a metal loss algorithm to determine the TTF value.
